(19) United States
(12) Patent Application Publication
(10) Pub. No.: US 2014/0108818 A1
(43) Pub. Date: Apr. 17, 2014

(54) METHOD OF ENCRYPTING AND DECRYPTING SESSION STATE INFORMATION

(71) Applicant: ELECTRONICS AND TELECOMMUNICATIONS RESEARCH INSTITUTE, Daejeon (KR)

(72) Inventors: Hee Bong CHOI, Daejeon (KR); Sang Yun HAN, Daejeon (KR); Kwang Jik YANG, Daejeon (KR); Hyuk Joong YOON, Daejeon (KR); Yongjin YEOM, Daejeon (KR)

(73) Assignee: ELECTRONICS AND TELECOMMUNICATIONS RESEARCH INSTITUTE, Daejeon (KR)

(21) Appl. No.: 13/958,543

(22) Filed: Aug. 3, 2013

(30) Foreign Application Priority Data
Oct. 12, 2012 (KR) 10-2012-0113337

(51) Int. Cl. G06F 21/60

(52) U.S. Cl. CPC G06F 21/602
USPC 713/189

(57) ABSTRACT

In a method of encrypting session state information, the value of a counter corresponding to session state information to be encrypted is calculated based on the ID of a cryptographic session corresponding to the session state information to be encrypted and the value of a session termination counter for the cryptographic session. The session state information to be encrypted is encrypted based on the calculated value of the counter and a preset key.

### CROSS REFERENCE TO RELATED APPLICATION

This application claims the benefit of Korean Patent Application No. 10-2012-0113337, filed Oct. 12, 2012, winch is hereby incorporated by reference in its entirety into this application.

### BACKGROUND OF THE INVENTION

1. Technical Field

The present invention relates generally to a method of encrypting and decrypting session stale information and, more particularly, to a method that is capable of securely encrypting and decrypting the session state information of a plurality of sessions that are supported by a cryptographic product.

2. Description of the Related At

Information protection products that are executed on at computer in or to protect personal information, financial information and the information and communication of public organizations are widely used.

Such information protection products are software, and adopt program obfuscation, secure key storage, integrity checking, etc. as protection measures.

The secure storage of confidential information is required for a case in which confidential information is stored in a hard disk, USB memory or a security token for a long period, and a ease in which confidential information resides in volatile memory, such as a register or RAM, to allow a cryptographic operation to be performed program is operating.

In general, in mainly products, confidential information that resides in volatile memory, such as a register or RAM, to perform a cryptographic operation exists in the form of plain text.

When a cryptographic product supports a plurality of cryptographic sessions, a lot of pieces of session state information tend to reside in volatile memory in the form of plain text. In this case, confidential information can be easily hacked by a malicious program that can analyze volatile memory. Such information protection products are vulnerable in that sensitive information that should be protected, may be divulged because confidential information required for a cryptographic operation divulged.

There is a case in which session state information residing in volatile memory is encrypted using a key. In this case, it is difficult to obtain session state information, unlike in the case where confidential information exists in volatile memory in the form of plain text.

However, when session state information is always encrypted using the same key and the same initial value, the encrypted text becomes vulnerable. Accordingly, session state information may be encrypted using a different key and a different initial value in each cryptographic session, in which case the management of keys or initial values for many sessions becomes complicated.

As described above, information protection products that are used to protect personal information, financial information and the information and communication of public organizations require the secure storage of confidential information residing in volatile memory, such as a register or RAM, in order to protect information against memory analysis attacks.

Meanwhile, when an encryption program supports a plurality of cryptographic sessions, a lot of session state information resides in volatile memory. In this case, in order to securely protect session state information, encryption should be performed. Generally, cryptographic sessions are large in number and randomly created and terminated, and thus there is difficulty in securely encrypting session state information.

Korean Patent Application Publication No. 10-2010-0099871 entitled “Memory for Data Protection, Memory System including the Memory, and Method of operating the Memory System” discloses a scheme for preventing an encryption key or data from being divulged to the outside. When memory performs an encryption or decryption operation, the technology disclosed in the Korean patent application publication receives an encryption key directly from a user and stores the encryption key in an area that is known to the user. Then the technology enables the user to select a different encryption key for a specific area or address of the memory. As to result, data or encryption keys a the memory can be protected from being divulged during an external attack, and reliable operations of encrypting and decrypting the data of the memory can be performed.

However, the technology disclosed in the Korean patent application publication can protect data or encryptions keys stored in memory from being divulged, but is problematic in that key management is difficult because N keys are required to protect data or encryption keys stored in N pieces of memory and in that encrypted text becomes vulnerable because it is always created when the same data is stored in the same memory.

### SUMMARY OF THE INVENTION

Accordingly, the present invention has been made keeping in mind the above problems occurring in the conventional art, and an object of the present invention is to provide a method that is capable of conveniently and securely encrypting and decrypting session state information residing in volatile memory, such as a register or random access memory (RAM), while a software cryptographic product for information protection is performing a cryptographic operation on a computer.

In accordance with an aspect of the present invention, there is provided a method of encrypting session state information, including calculating the value of a counter corresponding to session state information to be encrypted based on the ID of a cryptographic session corresponding to the session state information to be encrypted and the value of a session termination counter for the cryptographic session; and encrypting the session state information to be encrypted based on the calculated value of the counter and at preset key.

The session state information to be encrypted may be plain text session state information.

Calculating the value of the counter may include calculating the value of the counter using an operation mode counter that is used in the CTR operation mode of a block cryptographic algorithm. the value of the counter being calculated the formula (i−1)*T+n*Pi*T, where i is the ID (1≦i≦n) of the cryptographic session corresponding to session state information to be encrypted, T is M/m, M is a bit size of the session state information to be encrypted, m is a plain text bit size of the block cryptographic algorithm, n is a maximum number of cryptographic sessions, and Pi is tile value of the session termination counter of the cryptographic session corresponding to the session state information to be encrypted.

The value of the session termination counter may increase by one whenever the session state information to be encrypted is encrypted, and be stored in memory.

When the session state information to be encrypted is encrypted, the value of the session flag of the cryptographic session corresponding to the encrypted session state information may be set to 1, and be stored in memory.

When the value of the session flag is 1, the value of the session termination counter of the cryptographic session corresponding to the session state information to be encrypted may be increased by one, and be stored in the memory.

The method may further include storing the encrypted session state information in memory.

In accordance with another aspect of the present invention there is provided a method of decrypting session state information, including reading session state information to be decrypted from memory; calculating a value of a counter corresponding to the read session state information to be decrypted, the value of the counter being calculated based on an ID of a cryptographic session corresponding to the session state information to be decrypted and a value of a session termination counter for the cryptographic session; and decrypting the session state information to be decrypted based on the calculated value of the counter and a preset key.

Decrypting the session state information may include performing decryption on the CTR operation mode of a block cryptographic algorithm.

Calculating the value of the counter ma include calculating the value of the counter using an operation mode counter that is used in as CTR operation mode of a block cryptographic algorithm, the value of the counter being calculated the formula (i−1)*T+n*Pi*T, where i is the ID (1≦i≦n) of the cryptographic session corresponding to session state information to be decrypted, T is M/m, M is a bit size of the session state information to be decrypted, m is a plain text bit size of the block cryptographic algorithm, n is a maximum number of cryptographic sessions, and Pi is the value of the session termination counter of the cryptographic session corresponding to the session state information to be decrypted.

### BRIEF DESCRIPTION OF THE DRAWINGS

The above and other objects, features and advantages of the preset invention will be more clearly understood from the following detailed description taken in conjunction with the accompanying drawings, in which:

FIG. 1 is a diagram illustrating a process in which a cryptographic product terminates a cryptographic operation in a cryptographic session and encrypts session state information in order to cause the session state information in volatile memory according to an embodiment of the present invention;

FIG. 2 is a flowchart illustrating a method of encrypting session state information according to an embodiment of the present invention;

FIG. 3 is a diagram illustrating a process in which a cryptographic product decrypt encrypted session state information residing in volatile memory when the cryptographic product restarts a cryptographic operation in a cryptographic session according to an embodiment of the present invention; and

FIG. 4 is a flowchart illustrating a method of decrypting session state information according to an embodiment of the present invention.

### DESCRIPTION OF THE PREFERRED EMBODIMENTS

The present invention presents a method that is capable of conveniently and securely encrypting and decrypting the session state information of a plurality of cryptographic sessions that are frequently and non-sequentially created and terminated using a CTR operation mode on the assumption that a secure cryptographic algorithm is used.

A method of encrypting and decrypting session state information according to embodiments of the present invention will be described below with reference to the accompanying drawings. Prior to the following detailed description of the present invention, it should be noted that the terms and words used in the specification and the claims should not be construed as being limited to ordinary meanings or dictionary definitions. Meanwhile, the embodiments described in the specification and the configurations illustrated in the drawings are merely examples, and do not exhaustively present the technical spirit of the present invention. Accordingly, it should be appreciated that there may be various equivalents and modifications that can replace the examples at the time at which the present application is filed.

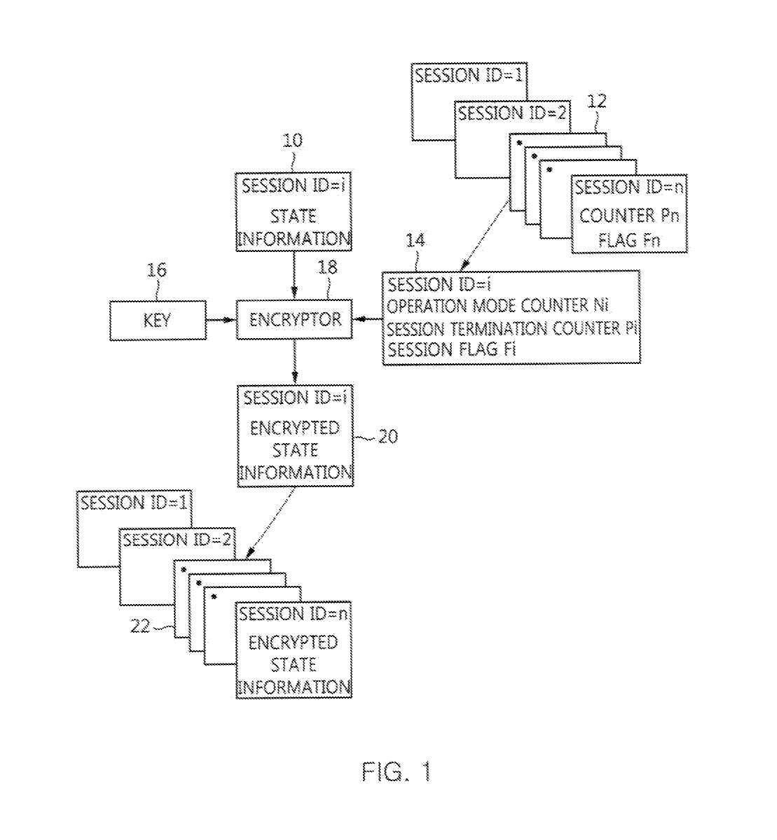

FIG. 1 is a diagram illustrating a process in which a cryptographic product terminates a cryptographic operation in a cryptographic session i and encrypts session state information in order to cause the session state information in volatile memory according to embodiment of the present invention.

In FIG. 1, reference numeral 10 designates session state information to be encrypted, which is plain text, in cryptographic session i.

Reference numeral 12 indicates that a session termination counter and a session flag corresponding to each of n cryptographic session IDs are stored in volatile memory. Although encrypted state information disappears because of the termination of a cryptographic session, a session termination counter and a session flag corresponding to the cryptographic session should be stored, and is used when the cryptographic session is created again and new state information is encrypted. In other words, since the cryptographic session i is terminated by being closed, infermation about a session termination counter Pi and a session flag Fi corresponding to the cryptographic session should be stored even when encrypted session state information disappears. The reason tom this is that when the cryptographic session i is opened again and new session state information encrypted the session termination counter Pi and the session flag Fi for the corresponding cryptographic session i should be used.

Reference numeral 14 designates an operation mode counter Ni, a session termination counter Pi, and a session flag Fi corresponding to session state information in which a cryptographic session ID corresponds to 1≦i≦n. In this case, the operation mode counter is not stored, but is obtained by calculation. That is, the operation mode counter is calculated using the equation “Ni=(i−1)*T+n*Pi*T (where Ni at m/2 bit counter).” In this case, at is the plain text bit size of a block cryptographic algorithm. The session termination counter Pi refers to the number of times the session has been terminated, and the session flag Fi is “1” when the session state information has been encrypted. The values of the session termination counter Pi and the session flag Fi are stored in the volatile memory. In the above equation that calculates the value of the operation mode counter Ni, i is the ID (1≦i≦n) of a cryptographic session corresponding to session state information to be encrypted, and T is M/m. M is the bit size of the session state information, and m is the plain text bit size of the block cryptographic algorithm. n is the maximum number of sessions that are supported by a cryptographic product, that is, the maximum number of cryptographic sessions, and Pi is the value of the session termination counter of the cryptographic session corresponding to the session state information to be encrypted. The value of the session termination counter increases by one whenever session state information to be encrypted is encrypted, that in, whenever a session is terminated and then the session is used again, and the value of the session termination counter is stored in volatile memory (not illustrated).

The operation mode counter Ni is used as at counter value in CTR (counter) operation mode when an encryptor 18 performs encryption. The session termination counter Pi increases by one whenever the cryptographic session i is closed.

A key 16 is a key K that is used for the encryption of the encryptor 18. Here, the key 16 may be referred to as an encryption key or a private key, and is preset. For example, the key 16 may be input by a user, or may be previously stored in memory.

The encryptor 18 performs encryption based Oh the CTR operation mode of the block cryptographic algorithm. The encryptor 18 encrypts the session state information 10 to be encrypted using the key 16 and the operation mode counter Ni of reference numeral 14. In this case, the session state information 10 to be encrypted is plain text session state information, and the operation mode counter Ni increases by one for each plain text size m. As described above, the present invention uses the always varying value of the CTR operation mode counter Ni additionally, thereby overcoming the vulnerability of an encrypted text, which is the problem of conventional technology. In other words, the present invention uses the always varying value of the CTR operation mode counter Ni whenever it performs encryption, thereby overcoming the vulnerability of encrypted text that occurs when encryption is performed using the same key and the same initial value in the conventional technology. Furthermore, the conventional technology may encrypt session state information using a different key and an initial value in each cryptographic session. In this case, the management of keys or initial values for many sessions is complicated, but the management is easy in the case of the present invention because the present invention uses the single key 16.

Reference numeral 20 designates encrypted session state information for which the cryptographic session ID corresponds to 1≦i≦n. Here, i is a cryptographic session ID corresponding to session state information to be encrypted or encrypted,

Reference numeral 22 indicates that a plurality of pieces of encrypted session state information is stored in volatile memory. Here, n is the maximum number of sessions that are supported by the cryptographic product, the session ID is a number that identifies the corresponding cryptographic session (in this case, the maximum value of the session ID is n), and the session state information size is in mT bits. Here m is the plain text size that is used in the cryptographic algorithm of the encryptor 18.

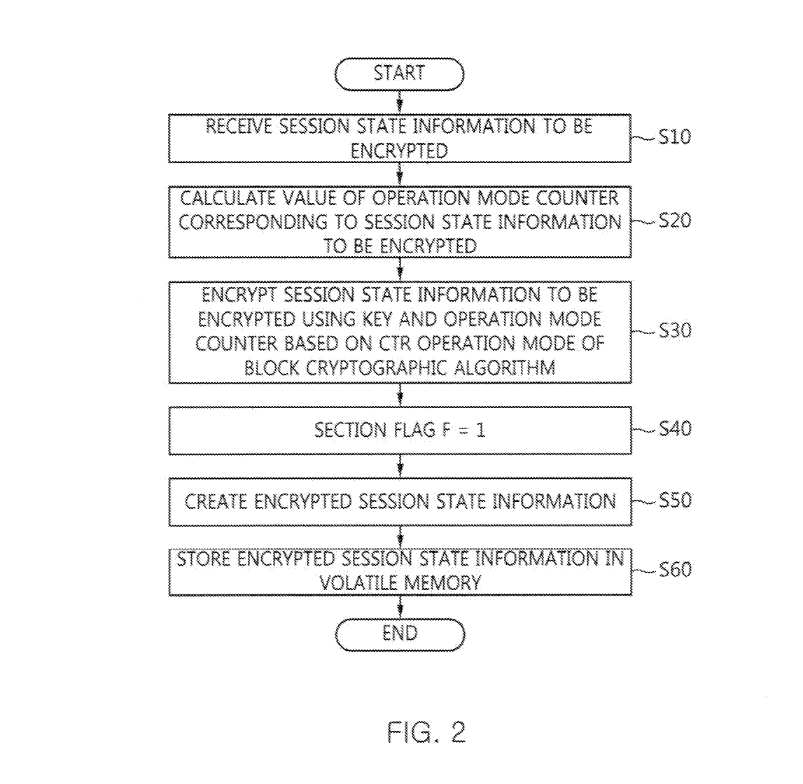

FIG. 2 a flowchart illustrating a method of encrypting session state information according to an embodiment of the present invention.

Prior to shifting to another cryptographic session after a cryptographic operation at the cryptographic session i, the session state information of the corresponding cryptographic session i should be encrypted and stored in volatile memory. An encryption process in this case will be described below.

In this case, prior to shifting from the cryptographic session i to the other cryptographic session, the session state information of the corresponding cryptographic session i is plain text session state information.

It is assumed that prior to encryption, the session termination counter Pi and session flag Fi have been initialized to 0 (1≦i≦n) and 0 (1≦i≦n), respectively,

The encryptor 18 receives session state information 10 to be encrypted, that is, session state information prior to shifting to the other cryptographic session after the cryptographic operation of the cryptographic session i, at step S10. Here, if the value of the session flag Fi is “1,” the session termination counter Pi increase its own current value by “1.”

Thereafter, the value of the operation mode counter Ni corresponding to the session state information to be encrypted is calculated. That is, the operation mode counter calculates the value of the corresponding operation mode counter using the equation “Ni=(i−1)*T+n*Pi*T” at step S20. Here, i is the ID (1≦i≦n) of the cryptographic session corresponding to the session state information to be encrypted, and T is M/m. M is the bit sin of the session state information, and m is the plain text bit size of the block cryptographic algorithm. n is the maximum number of sessions that are supported by the cryptographic product, that is, the maximum number of cryptographic sessions, and Pi is the value of the session termination counter of the cryptographic session corresponding to the session state information to be encrypted.

Thereafter, the encryptor 18 encrypts the session state information 10 to be encrypted using the preset key 16 and the calculated value of the operation mode counter based on the CTR operation of the mode block cryptographic algorithm at step S30.

Once the session state information has been encrypted as described above, the session flag F maintains its own current value at “1” at step S40, and session state information 20 encrypted by the encryptor 18 is created at step S50.

Thereafter, the encryptor 18 causes the session state information 20 finally encrypted for the corresponding cryptographic session i to reside in volatile memory at step S60.

In the above descriptions of FIGS. 1 and 2, the calculation of the value of the operation mode counter, the adjustment of the value of the session flag, and the adjustment of the value of the session termination counter may be performed by the encryptor 18 or a separate control unit (not illustrated).

In the above described encryption method according to the embodiment of the present invention session state information may be encrypted using the preset key 16 (that is, a key that is used for encryption) and the always varying CTR operation mode counter value.

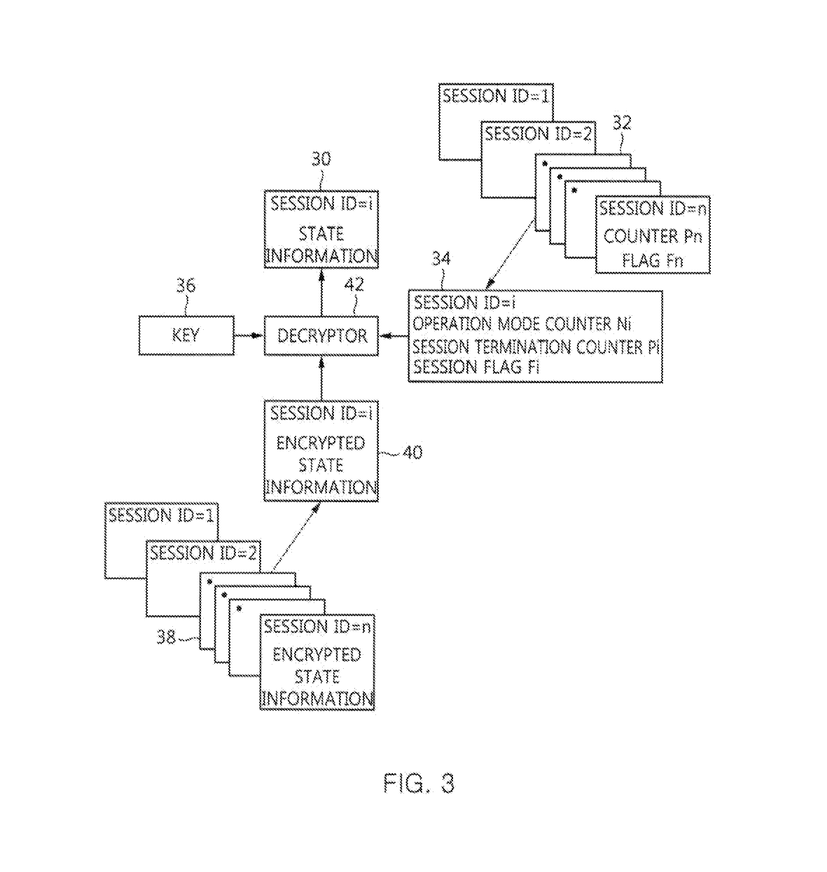

FIG. 3 is a diagram illustrating a process in which the cryptographic product decrypts the encrypted session state information residing in the volatile memory when the cryptographic product restarts a cryptographic operation to the cryptographic session i according to an embodiment of the present invention.

In FIG. 3, reference numeral 30 indicates that encrypted session state information 40 has been decrypted when a cryptographic operation is restarted in the cryptographic session i. That is, reference numeral 30 designates decrypted session state information.

Reference numeral 32 indicates that a session termination counter and a session flag corresponding to each of n cryptographic session IDs have been stored in the volatile memory.

Reference numeral 34 designates an operation mode counter a session termination counter Pi, and a session flag Fi corresponding to session state information for which a cryptographic session ID corresponds to 1≦i≦n. Here, the operation mode counter Ni is not stored, but is obtained by calculating. That is, the operation include counter Ni calculated using the equation “Ni=(i−1)*T+n*Pi*T (where N is an m/2 bit counter.” The session flag Fi is “1” when the session state information has been encrypted. The values of the session termination counter Pi and the session flag Fi are stored in the volatile memory. In the above equation that calculates the value of the operation mode counter Ni, i is the ID (1≦i≦n) of a cryptographic session corresponding to the session state information to be decrypted, and T is M/m. M is the bit size of the session state information, and m is the plain text bit size of the block cryptographic algorithm. n is the maximum number of sessions that are supported by a cryptographic product, that is, the maximum number of cryptographic sessions, and Pi is the value of the session termination counter of the cryptographic session i corresponding to the session state information to be decrypted.

The operation mode counter Ni is used as a counter value in CTR (counter) operation mode when a decryptor 18 performs decryption.

A key 36 is a key K that is used for the decryption of the decryptor 18. Here, the key 36 may be, referred to as a decryption key or a private key, and is preset. For example, the key 36 may be input by a user, or may be previously stored in memory. In these embodiments of the present invention, the key 36 that is used for decryption and the key 16 that is used for encryption are the same. When the key 36 that is used for decryption and the key 16 that is used for encryption are the same, session state information can be encrypted and decrypted using a single encryption and decryption key and an always varying CTR operation mode counter value.

Reference numeral 38 indicates that a plurality of pieces of encrypted session state information has been stored in the volatile memory.

Reference numeral 40 designates encrypted session state information for which the cryptographic session ID corresponds to 1≦i≦n.

The decryptor 42 performs decryption based on the CTR operation mode of the block cryptographic algorithm. The decryptor 42 decrypts the encrypted session state information 40 using the key 36 and the operation mode counter Ni. In this case, the operation mode counter Ni increases by one for each plain text size m. As described above, the present invention uses the always varying value of the CTR operation mode counter Ni additionally, thereby reducing the risk of the divulgence of sensitive information, which is the problem of conventional technology. In other words, the present invention uses the always varying value of the CTR operation mode counter Ni whenever it performs decryption, thereby reducing the risk of the divulgence of sensitive information that occurs when decryption is performed using the same key and the same initial value in the conventional technology. Furthermore, the conventional technology may decrypt session state information using a different key and an initial value in each cryptographic session. In this case, the management of keys and initial values for many sessions is complicated, but the management is easy in the case of the present invention because the present invention uses a single key.

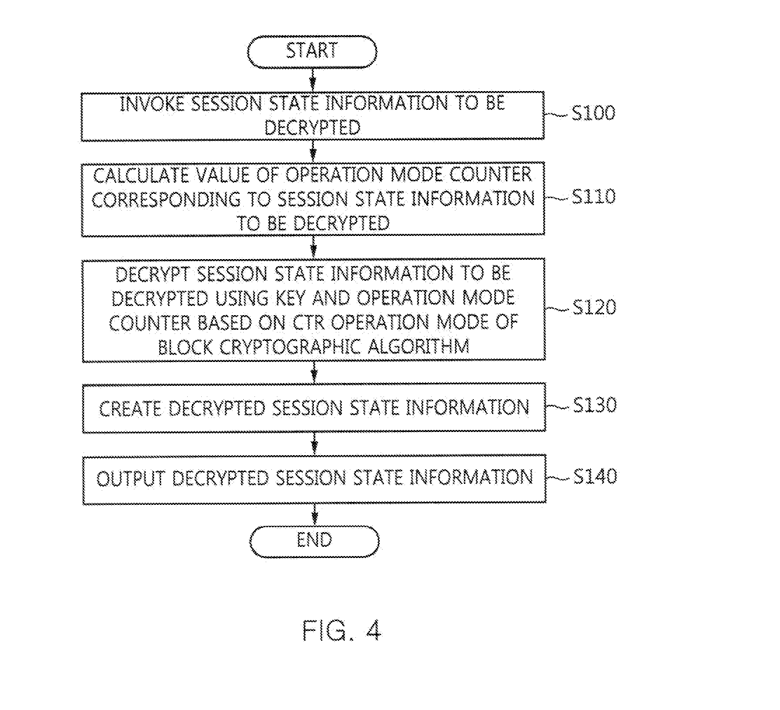

FIG. 4 is a flowchart illustrating a method of decrypting session state information according to an embodiment of the present invention.

In order to invoke the cryptographic session i, the session state information of the corresponding cryptographic session i residing in the volatile memory should be decrypted. The decryption process in this case swill be described below.

The decryptor 42 invokes the encrypted session state information 40 of the cryptographic session i to be decrypted from among cryptographic sessions residing in the volatile memory at step S100.

Thereafter, the value of the operation mode counter Ni corresponding to the encrypted session state information 40 to be decrypted is calculated. That is, the operation mode counter calculates the value of the corresponding operation mode counter using the equation “N=(i−1)*T+n*Pi*T” at step S10. Here, i is the ID (1≦i≦n) of a cryptographic session corresponding to the session state information to be decrypted, and T is M/m. M is the bit size of the session state information, and m is the plain text bit size of the block cryptographic algorithm. n is the maximum number of sessions that are supported by the cryptographic product, that is, the maximum number of cryptographic sessions, and Pi is the value of the session termination counter of the cryptographic session corresponding to the session state information to be decrypted.

Thereafter, the decryptor 42 decrypts the encrypted session state information 40 to be decrypted using the preset key 36 and the calculated value of the operation mode counter based on the CTR operation of the mode block cryptographic algorithm at step S120.

When the encrypted session state information is decrypted as described above, the decrypted session state information is created by the decryptor 42 at step S130.

Thereafter, the decryptor 42 outputs the finally decrypted session state information 30 for the corresponding cryptographic session at step S140.

In the above descriptions of FIGS. 3 and 4, the calculation of the value of the operation mode counter, the adjustment of the value of the session flag, and the adjustment of the value of the session termination counter may performed by the decryptor 18 or a separate control unit (not illustrated).

In the above-described decryption method according to this embodiment of the present invention, encrypted session state information may be decrypted using the preset key 36 (that is, a key that is used for decryption) and the always varying CTR operation mode counter value.

According to the present invention configured as described above, session state information is encrypted and decrypted with the initial value of the counter of the CTR operation mode associated with a session D. Although a conventional technology stores a session ID and session state information to manage a cryptographic session, the present invention stores a session ID, session state information, a session termination counter, and a session flag to manage a cryptographic session. When the method according to the prevent invention is used, the method is advantageous in that session state information is encrypted and decrypted using a single encryption/decryption key and an always varying CTR operation mode counter value.

According to the present invention, session state information residing in volatile memory can be securely stored, and thus it is very difficult to hack confidential information about cryptographic session state volatile memory while a program is being executed.

Furthermore, the management of a key is convenient because cryptographic session state information residing in volatile memory can be encrypted and decrypted using a single key even when sessions are frequently created and terminated non-sequentially, and security can be improved because always varying encrypted text can be created for the same plain text.

Accordingly, the present invention has the advantage of improving the security of the confidential information, such as a key and authentication information, of software-type information protection products that are executed on a computer.

Furthermore, the present invention may be implemented as computer-readable code stored in a computer-readable storage medium. The computer-readable storage medium includes all types of storage devices in which computer system-readable data is stored. Examples of the computer-readable storage medium are Read Only Memory (ROM), Random Access Memory (RAM), compact disk (CD)-ROM, magnetic tape, a floppy disk, and an optical data storage device. Furthermore, the computer-readable storage medium may be implemented as carrier waves (for example, to the case of transmission over the Internet). Moreover, the computer-readable medium may be distributed across computer systems connected via a network, so that computer-readable code can be stored and executed in a distributed manner.

Although the preferred embodiments of the present invention have been disclosed for illustrative purposes, those skilled in the art will appreciate that various modifications, additions and substitutions are possible, without departing from the scope and spirit at the invention as disclosed in the accompanying claims.

What is claimed is:

1. A method of encrypting session state information, comprising:
calculating a value of a counter corresponding to session state information to be encrypted based on an ID of a cryptographic session corresponding to the session state information to be encrypted and a value of a session termination counter for the cryptographic session; and
encrypting the session state information to be encrypted based on the calculated value of the counter and a preset key.

2. The method of claim 1, wherein the session state information to be encrypted is plain text session state information.

3. The method of claim 1, wherein calculating the value of the counter includes calculating the value of the counter using an operation mode winner that is used in a CTR operation mode of a block cryptographic algorithm,
the value of the counter being calculated the formula (i−1)*T+n*Pi*T, where is the ID (1≦i≦n) of the cryptographic session corresponding to session state information to be encrypted, T is M/m, M is a bit size of the session state information to be encrypted, m is a plain text bit size of the block cryptographic algorithm, n is a maximum number of cryptographic sessions, and Pi is the value of the session termination counter of the cryptographic session corresponding to the session state information to be encrypted.

4. The method of claim 3, wherein the value of the session termination counter increases by one whenever the session state information to be encrypted is encrypted, and is stored in memory.

5. The method of claim 1, wherein when the session state information to be encrypted is encrypted, a value of a session flag of the cryptographic session corresponding to the encrypted session state information is set to 1, and is stored in memory.

6. The method of claim 5, wherein when the value of the session flag is 1, the value of the session termination counter of the cryptographic session corresponding to the session state information to be encrypted is increased by one, and is stored in the memory.

7. The method of claim 1, further comprising storing the encrypted session state information in memory.

8. A method of decrypting session state information, comprising:
reading session state information to be decrypted from memory;
calculating a value of a counter corresponding to the read session state information to be decrypted, the value of the counter being calculated based on an of a cryptographic session corresponding to the session state information to be decrypted and a value of a session termination counter for the cryptographic session; and
decrypting the session state information to be decrypted based on the calculated value of the counter and a preset key.

9. The method of claim 8, wherein decrypting the session state information includes performing decryption on a CTR operation mode of a block cryptographic algorithm.

10. The method of claim 8, wherein calculating the value of the counter calculating the value of the counter using an operation mode counter that is used in a CTR operation mode of a block cryptographic algorithm,
the value of the counter being calculated the formula (i−1)*T+n*Pi*T, where i is the ID (1≦i≦n) of the cryptographic session corresponding to session state information to be decrypted, T is M/m, M is a bit size of the session state information to be decrypted, m is a plain text bit size of the block cryptographic algorithm, n is a maximum number of cryptographic sessions, and Pi is the value of the session termination counter of the cryptographic session corresponding to the session state information to be decrypted.
